(19) United States
(12) Patent Application Publication
(10) Pub. No.: US 2025/0027179 A1
(43) Pub. Date: Jan. 23, 2025

(54) System for Direct Reduction of Iron Ore to Sponge Iron

(71) Applicant: HYBRIT Development AB, Stockholm (SE)

(72) Inventor: Tommy Ruona, Luleå (SE)

(21) Appl. No.: 18/714,686

(22) PCT Filed: Oct. 26, 2022
(86) PCT No.: PCT/SE2022/050976

§ 371 Date: May 30, 2024

(30) Foreign Application Priority Data
Nov. 30, 2021 (SE) 2151459-1

(51) Int. Cl. C21B 13/12; C21B 13/00

(52) U.S. Cl. CPC C21B 13/12; C21B 13/0073

(57) ABSTRACT

A system for direct reduction of iron ore to sponge iron. The system includes a direct reduction shaft including an outer wall configured to withstand a pressure generated in the reduction shaft during operation thereof, and a heat resistant inner wall configured to protect the outer wall from heat and from direct contact with the iron ore that is reduced in the reduction shaft, the inner wall being arranged inside the outer wall and defining a process chamber in which the reduction of the iron ore takes place. The system includes an arrangement for introducing reduction gas into the process chamber that includes a plurality of reduction gas inlets extending through the outer wall and through the inner wall, wherein at each inlet there is provided a respective gas line for conducting reduction gas to the respective inlet, and wherein each gas line is provided with a respective heater device arranged outside the outer wall and configured to heat the reduction gas in the respective gas line before the reduction gas enters the process chamber through the respective inlet.

### TECHNICAL FIELD

The present invention relates to a system for direct reduction of iron ore to sponge iron, comprising:
a direct reduction shaft comprising
an outer wall configured to withstand a pressure generated in the reduction shaft during operation thereof, and
a heat resistant inner wall configured to protect the outer wall from heat and from direct contact with the iron ore that is reduced in the reduction shaft, the inner wall being arranged inside the outer wall and defining a process chamber in which the reduction of the iron ore takes place, and
an arrangement for introducing a reduction gas from outside the outer wall into the process chamber through the outer wall and through the inner wall.

### BACKGROUND

Systems for reduction iron ore to sponge iron comprise an arrangement for introducing the reduction gas into the process chamber. The reduction shaft mainly comprises an outer pressure vessel, typically made of steel, and an inner wall made of heat resistant material, refractory material. Inside the inner wall is the process chamber. The reduction gas shall have a predetermined temperature when entering the process chamber. In prior art this is solved by preheating the reduction gas in a main gas line in which it is conducted from a reduction gas source to the direct reduction shaft. The preheating arrangement is large and occupies a substantial area, also known as its footprint. It may comprise a chamber in which the main gas line (comprising a tube) follows a meander path and is heated by a burner arrangement in which fossil fuel is used. As an alternative, electric heaters have been suggested to replace fossil fuel burner heaters. The main gas line extends from the preheating arrangement and extends through a single inlet through the wall of the pressure vessel. Inside the pressure vessel, the main gas line becomes ring-shaped and runs around the outer periphery of the inner wall inside a ring-shaped body of heat resistant material arranged on an outer periphery of the inner wall. Through a plurality of outlets arranged on the inner periphery of the ring-shaped gas line and extending through the inner wall, the hot reduction gas is finally introduced into the process chamber of the direct reduction shaft.

Due to its considerable size, i.e., footprint, the preheating arrangement is often arranged at some distance from the direct reduction shaft, and hot gas has to be transported considerable distance via the main gas line from the preheating arrangement to the direction reduction shaft.

The ring-shaped body locally adds considerable thickness to the heat resistant inner wall of the direction reduction shaft. Due to the presence of the ring-shaped body, the outer wall will need to have an inner diameter which is excessively large in the area of the ring-shaped body, leaving a substantial gas-filled space between the outer wall and the inner wall in the region of the ring-shaped body.

It is a common problem to be solved to reduce the volume of hot inactive gas that will result in heat losses and/or excessive occupation of space. This is relevant for the hot reduction gas that at each moment exists in the system for direct reduction of iron or to sponge iron. Solving of the problem should preferably be done without complicating the design of large components of the shaft, such as the outer wall (the pressure vessel) or the heat resistant inner wall, and without reducing the effective volume of the reaction chamber.

### SUMMARY

It is an objective of the present invention to present a design which solves the above-mentioned problem.

The problem is solved by means of a system for direct reduction of iron ore to sponge iron, comprising:
a direct reduction shaft comprising:
an outer wall configured to withstand a pressure generated in the reduction shaft during operation thereof, and
a heat resistant inner wall configured to protect the outer wall from heat and from direct contact with the iron ore that is reduced in the reduction shaft, the inner wall being arranged inside the outer wall and defining a process chamber in which the reduction of the iron ore takes place, and
an arrangement for introducing a reduction gas from outside the outer wall into the process chamber through the outer wall and through the inner wall, the system being characterized in that the arrangement for introducing reduction gas into the process chamber comprises:
a plurality of reduction gas inlets extending through the outer wall and through the inner wall, wherein
at each inlet there is provided a respective gas line for conducting reduction gas to the respective inlet, and wherein
each gas line is provided with a respective heater device arranged outside the outer wall and configured to heat the reduction gas in the respective gas line before the reduction gas enters the process chamber through the respective inlet.

By having individual inlets through the outer wall, distribution of the reduction via a ring-shaped body provided between the outer wall and the inner wall becomes unnecessary. Excessive spacing between the outer wall and the inner wall, which would be occupied by inactive gas, can thus be avoided and the design of the outer wall the inner wall can be kept uncomplicated in the region of the reduction gas inlets. According to one embodiment, the outer wall is generally parallel with the inner wall in the region of the reduction gas inlets, having a distance to the inner wall corresponding to the distance between the outer wall and the inner wall remote from the region of the reduction gas inlets. Dedicating each inlet with a respective heater device will also make it possible to reduce the distance between heaters and inlets, and will thus contribute to a reduction of total volume of heated, inactive reduction gas in the system.

According to one embodiment, each respective heater device comprises an electric heater device. Electric heater devices may be compact, and be given a relatively small footprint, and may thus be positioned in rather high numbers close to the outer wall without interfering with each other in terms of required space.

According to one embodiment, each respective heater device comprises an electric resistance element arranged in a channel which forms part of the respective gas line and which is configured to conduct the reduction gas therein. This will enable each heater device to have an extension in the vertical direction which is substantially larger than its maximum extension in a horizontal direction. Thereby a large number of heaters may be arranged around the outer periphery of the outer wall at a close distance to the wall.

According to one embodiment, each heater device comprises one or more electric resistance elements arranged in a channel which forms part of the respective gas line and which is configured to conduct the reduction gas therein, and wherein each resistance element extends with its longitudinal axis in a generally vertical direction, and wherein each heater device has an extension in the vertical direction which is substantially larger than its maximum extension in a horizontal direction. The footprint of each heater device thereby becomes relatively small compared to the output of the heater device. Thereby a large number of heaters may be arranged around the outer periphery of the outer wall at a close distance to the wall.

According to one embodiment, the heater devices are evenly distributed around the outer periphery of the outer wall.

According to one embodiment, the respective heater device is configured to heat the reduction gas flowing through the heater device to a requested temperature that the reduction gas shall have when entering the process chamber.

According to one embodiment, each gas line is provided with a first valve provided downstream the gas heater device, between the inlet and the gas heater device. Individual disconnection of a defective heater from the interior of the shaft is thus enabled.

According to one embodiment, each gas line is provided with a second valve arranged upstream the gas heater device. Individual disconnection of a defective heater from the interior of the shaft is thus enabled.

According to one embodiment, the arrangement for introducing a reduction gas comprises a main reduction gas line, which is connected to a reduction gas source in one end and to each of the respective gas lines associated to a respective inlet in another end.

According to one embodiment, the main gas line forms a ring channel extending circumferentially around the outer periphery of the outer wall, wherein each of said gas lines is in communication in one end with said ring channel of the main gas line, and wherein the main gas line comprises a main channel connected in one end with the ring channel and in another end with the reduction gas source.

According to one embodiment, the arrangement for introducing a reduction gas comprises said reduction gas source.

According to one embodiment, the reduction gas source is a gas source configured to deliver a reduction gas that comprises at least 80 vol. % hydrogen, preferably at least 90 vol. % hydrogen. The gas source may comprise an electrolyser unit providing fresh hydrogen gas. It may also comprise a line with conditioned hydrogen-containing off-gas from the direction reduction shaft.

According to one embodiment, the direct reduction shaft comprises an iron ore inlet at the top of the shaft, and the reduction gas inlets for introduction of the reduction gas into the process chamber are located at a level substantially below the iron ore inlet, and there is at least one off-gas outlet provided at a level above the level of the reduction gas inlets, and there is provided a sponge iron outlet at a level below the level of the reduction gas inlets. The shaft has a longitudinal direction parallel with the vertical axis. The reduction gas inlets and the heater device are positioned at a level corresponding to a bottom end of the part of the process chamber in which the direction reduction takes place. If the process chamber of the direction reduction shaft comprises a carburization chamber directly below the part of the process chamber in which the direct reduction takes place, such a level may be at a considerable level above ground.

According to one embodiment, the direct reduction shaft has a height in the range of 50-150 meters and a diameter in the range of 4-10 meters, and each heater device has a height in the region of 5-15 meters and a maximum width of 2-5 meters.

### BRIEF DESCRIPTION OF THE DRAWINGS

FIG. 1 is a schematic side view of a system according to an embodiment of the present invention, and

FIG. 2 is a view from above of the system disclosed in FIG. 1.

### DETAILED DESCRIPTION

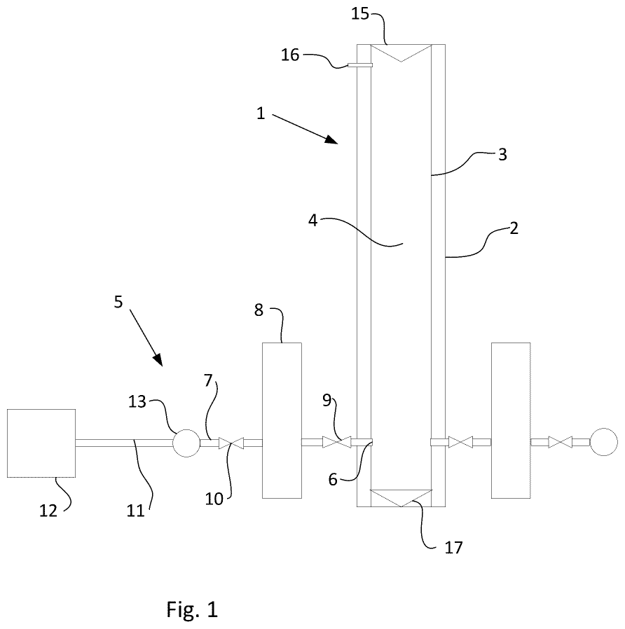

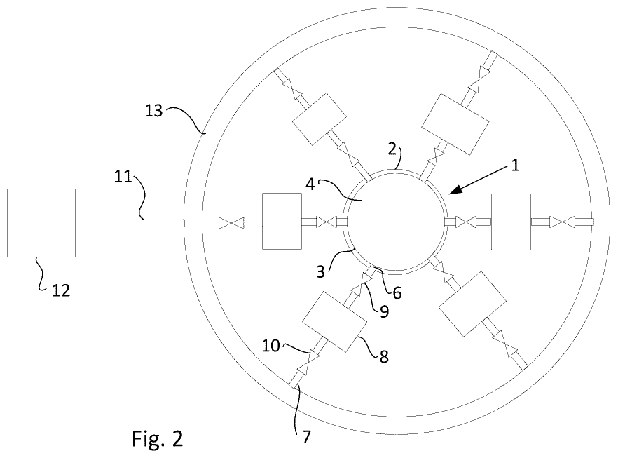

Reference is made to FIGS. 1 and 2. The system is a system for direct reduction of iron ore to sponge iron.

The system comprises a direct reduction shaft 1 which comprises an outer wall 2 configured to withstand a pressure generated in the reduction shaft during operation thereof, and a heat resistant inner wall 3 configured to protect the outer wall 2 from heat and from direct contact with the iron ore that is reduced in the reduction shaft 1. The inner wall 3 is arranged inside the outer wall 2 and defines a process chamber 4 in which the reduction of the iron ore takes place.

The system further comprises an arrangement 5 for introducing a reduction gas from outside the outer wall 2 into the process chamber 4 through the outer wall 2 and through the inner wall 3.

The arrangement 5 for introducing reduction gas into the process chamber 4 comprises a plurality of reduction gas inlets 6 extending through the outer wall 2 and through the inner wall 3. At each inlet 6 there is provided a respective gas line 7 for conducting reduction gas to the respective inlet 6. Each gas line 7 is provided with a respective heater 8 device arranged outside the outer wall 2 and configured to heat the reduction gas in the respective gas line 7 before the reduction gas enters the process chamber 4 through the respective inlet 6.

Each respective heater device 8 comprises an electric heater device, wherein each respective heater 8 device comprises an electric resistance element (not shown) arranged in a channel which forms part of the respective gas line and which is configured to conduct the reduction gas therein. Such heaters may be referred to as gas flow heaters. More precisely, each heater device comprises a plurality of electric resistance elements arranged in a channel which forms part of the respective gas line and which is configured to conduct the reduction gas therein. Each resistance element extends with its longitudinal axis in a generally vertical direction, and each heater device 8 has an extension in the vertical direction which is substantially larger than its maximum extension in a horizontal direction. The respective heater device 8 is configured to heat the reduction gas flowing through the heater device 8 to a requested temperature that the reduction gas shall have when entering the process chamber 4.

The heater devices 8 are evenly distributed around the outer periphery of the outer wall 7.

Each gas line 7 is provided with a first valve 9 provided downstream the gas heater device 8 as seen in the gas flow direction, between the inlet 6 and the gas heater device 8. Each gas line 7 is also provided with a second valve 10 arranged upstream the gas heater device 8. The first and second valves 9, 10 are controllable valves.

The arrangement 5 for introducing a reduction gas comprises a main reduction gas line 11, which is connected to a reduction gas source 12 in one end and to each of the respective gas lines 7 associated to a respective inlet 6. In the embodiment shown, the main gas line 11 forms a ring channel 13 extending circumferentially around the outer periphery of the outer wall and circumferentially outside the group of heater devices 8. Each of the gas lines 7 is in communication in one end with said ring channel 13 of the main gas line 11. The main gas line 11 comprises a main channel 14 connected in one end with the ring channel 13 and in another end with the reduction gas source 12.

The arrangement 5 for introducing a reduction gas comprises said reduction gas source 12. The reduction gas source 12 is a gas source configured to deliver a reduction gas that comprises at least 90 vol. % hydrogen. The gas source 12 comprises a hydrolyser unit providing fresh hydrogen gas. It may also comprise a line (not shown) with conditioned hydrogen-containing off-gas from the direction reduction shaft.

The direct reduction shaft 1 comprises an iron ore inlet 15 at the top of the shaft, and the reduction gas inlets 6 for introduction of the reduction gas into the process chamber are located at level substantially below the iron ore inlet 15. There is an off-gas outlet 16 provided at the top of the shaft 1, i.e., above the reduction gas inlets 6. There is provided a sponge iron outlet 17 at the bottom of the shaft 1, i.e., at a level below the level of the reduction gas inlets 6. The shaft 1 has a longitudinal direction and a longitudinal axis parallel with the vertical axis. The reduction gas inlets 6 and the heater devices 8 are positioned at a level corresponding to a bottom end of the part of the process chamber 4 in which the direction reduction takes place.

According to one embodiment, the direct reduction shaft has a height of 100 meters and a diameter of 7 meters, and each heater device has a height of 10 meters and a maximum width of 3 meters.

1. A system for direct reduction of iron ore to sponge iron, comprising:
a direct reduction shaft comprising:
an outer wall configured to withstand a pressure generated in the reduction shaft (1) during operation thereof, and
a heat resistant inner wall configured to protect the outer wall from heat and from direct contact with the iron ore that is reduced in the reduction shaft, the inner wall being arranged inside the outer wall and defining a process chamber in which the reduction of the iron ore takes place, and
an arrangement for introducing a reduction gas from outside the outer wall into the process chamber through the outer wall and through the inner wall, wherein the arrangement for introducing reduction gas into the process chamber comprises:
a plurality of reduction gas inlets extending through the outer wall and through the inner wall, wherein
at each inlet there is provided a respective gas line for conducting reduction gas to the respective inlet, and wherein
each gas line is provided with a respective heater device arranged outside the outer wall and configured to heat the reduction gas in the respective gas line before the reduction gas enters the process chamber through the respective inlet.

2. A system according to claim 1, wherein each respective heater device comprises an electric heater device.

3. A system according to claim 2, wherein each respective heater device comprises an electric resistance element arranged in a channel which forms part of the respective gas line and which is configured to conduct the reduction gas therein.

4. A system according to claim 1, wherein each heater device comprises one or more electric resistance elements arranged in a channel which forms part of the respective gas line and which is configured to conduct the reduction gas therein, and wherein each resistance element extends with its longitudinal axis in a generally vertical direction, and wherein each heater device has an extension in the vertical direction which is substantially larger than its maximum extension in a horizontal direction.

5. A system according to claim 1, wherein the heater devices are evenly distributed around the outer periphery of the outer wall.

6. A system according to claim 1, wherein the respective heater device is configured to heat the reduction gas flowing through the heater device to a requested temperature that the reduction gas shall have when entering the process chamber.

7. A system according to claim 1, wherein each gas line is provided with a first valve provided downstream the gas heater device, between the inlet and the gas heater device.

8. A system according to claim 1, wherein each gas line is provided with a second valve arranged upstream the gas heater device.

9. A system according to claim 1, wherein the arrangement for introducing a reduction gas comprises a main reduction gas line, which is connected to a reduction gas source in one end and to each of the respective gas lines associated to a respective inlet.

10. A system according to claim 9, wherein the main gas line forms a ring channel extending circumferentially around the outer periphery of the outer wall, and that each of said gas lines is in communication in one end with said ring channel of the main gas line, and wherein the main gas line comprises a main channel connected in one end with the ring channel and in another end with the reduction gas source.

11. A system according to claim 9, wherein the arrangement for introducing a reduction gas comprises said reduction gas source.

12. A system according to claim 11, wherein the reduction gas source is a gas source configured to deliver a reduction gas that comprises at least 80 vol. % hydrogen, preferably at least 90 vol. % hydrogen.

13. A system according to claim 1, wherein the direct reduction shaft comprises an iron ore inlet at the top of the shaft, and that the reduction gas inlets for introduction of the reduction gas into the process chamber are located at level substantially below the iron ore inlet, and that there is at least one off-gas outlet provided at a level above the level of the reduction gas inlets, and that there is provided a sponge iron outlet at a level below the level of the reduction gas inlets.

14. A system according to claim 1, wherein the direct reduction shaft has a height in the range of 50-150 meters and a diameter in the range of 4-10 meters, and each heater device has a height in the region of 5-15 meters and a maximum width of 2-5 meters.
